(19) United States
(12) Patent Application Publication
(10) Pub. No.: US 2012/0267954 A1
(43) Pub. Date: Oct. 25, 2012

(54) LOAD LINE CALIBRATION DEVICE

(75) Inventors: FU-SEN YANG, Shenzhen City (CN); QI-YAN LUO, Shenzhen City (CN); PENG CHEN, Shenzhen City (CN); YUN BAI, Shenzhen City (CN); SONG-LIN TONG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/167,724

(22) Filed: Jun. 24, 2011

(30) Foreign Application Priority Data
Apr. 22, 2011 (CN) 201110101865.3

(51) Int. Cl. H02J 1/14

(52) U.S. Cl. 307/31

(57) ABSTRACT

An adjusting device adjusts a load line of a CPU power supply circuit. The adjusting device includes a controller, a DC electronic load device, a voltage follower, an adjustable resistor, and an indicator. The controller controls the DC electronic load device to change an output current of the circuit. The voltage follower sends an output voltage of the circuit to the controller. The controller calculates the load line of the circuit based on the output current and the output voltage of the circuit, determines whether the load line satisfies the required value, changes a resistance of the adjustable resistor until the load line satisfies the required value, and sends a resistance of the adjustable resistor to the indicator.

### BACKGROUND

1. Technical Field

The present disclosure relates to a calibration device for calibrating a load line of a CPU power supply circuit in a main board of a computer.

2. Description of Related Art

In a CPU power supply circuit, an output voltage decreases while an output current increases. A load line describes a relationship between the output voltage and the output current of the circuit. The load line represents a change in the output voltage when the output current increases by one ampere, that is, the load line=ΔV/ΔI.

A test for a main board of a computer usually includes a test of the load line of the CPU power supply circuit. However, if the load line is not a required value, the output voltage may be larger than or less than a working voltage of a CPU. If the output voltage is larger than the working voltage, the CPU may be damaged; if the output voltage is less than the working voltage, the CPU may not work.

A CPU power supply circuit typically includes a resistor, and a load line of the circuit can be changed by changing the resistor to another resistor of another value. In a typical adjustment method, the resistor is manually replaced with a different resistor, and then the load line of the circuit is tested again, and so on until a proper load line is achieved, which is inconvenient and time-consuming.

Therefore, it is desirable to provide an adjusting device, which can overcome the above-mentioned limitations.

### BRIEF DESCRIPTION OF THE DRAWING

The drawing is a functional block diagram of an adjusting device according to an embodiment.

### DETAILED DESCRIPTION

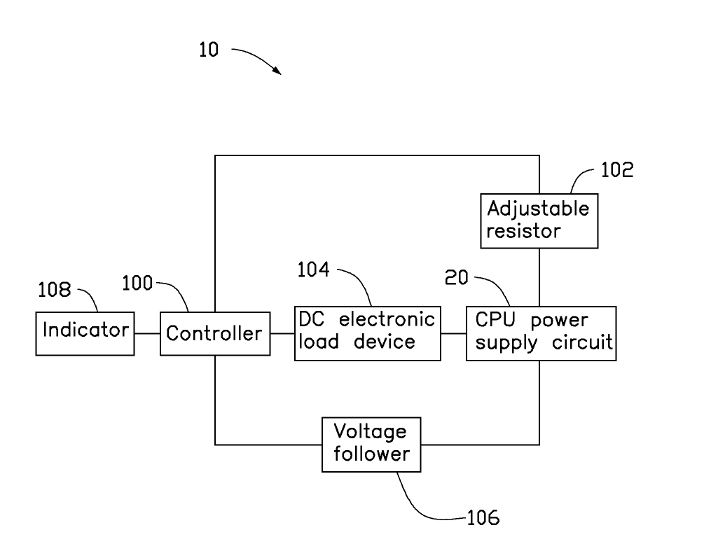

Referring to FIG. 1, an adjusting device 10 includes a controller 100, a direct current (DC) electronic load device 104, a voltage follower 106, an adjustable resistor 102, and an indicator 108. The adjusting device 10 can adjust a load line of a CPU power supply circuit 20.

The circuit 20 is on a main board (e.g., a motherboard) of a computer, and is configured for supplying power to a CPU of the computer. The circuit 20 includes a place for a resistor (not shown). The adjusting device 10 determines a proper resistance of a resistor to be installed in the resistor place in the circuit 20 so that the load line of the circuit 20 is set at a required value. Before determining the proper resistance of the resistor to be installed in the resistor place in the circuit 20, the adjustable resistor 102 is connected between the controller 100 and the circuit 20.

The controller 100 is for controlling the DC electronic load device 104, the adjustable resistor 102, and the indicator 108. The controller 100 may be a single chip microcomputer. In one embodiment, the controller 100 can be a single chip microcomputer type PIC16F73. The required load line value is preset in the controller 100, such as by the use of a matrix keyboard.

Resistance of the adjustable resistor 102 changes according to a digital signal from the controller 100. In one embodiment, the adjustable resistor 102 can be a digital potentiometer.

One end of the DC electronic load device 104 is connected to the controller 100, and the other end of the DC electronic load device 104 is connected to the circuit 20. The controller 100 controls the DC electronic load device 104 to change an output current of the circuit 20.

An input terminal of the voltage follower 106 is connected to the circuit 20, and an output terminal of the voltage follower 106 is connected to the controller 100. The voltage follower 106 is for sending an output voltage of the circuit 20 to the controller 100.

Input terminals of the indicator 108 are connected to the controller 100. The indicator 108 is for indicating successful adjustment of the load line of the circuit 20. The indicator 108 may be a visual and/or audio indicator and indicate what the resistance of the resistor to be installed in the resistor place of the circuit 20 should be to achieve the desired load line. In the present embodiment, the indicator 108 can be a liquid crystal display.

To adjust the load line, the controller 100 controls the DC electronic load device 104 to change an output current of the circuit 20, and the voltage follower 106 sends a corresponding output voltage of the circuit 20 to the controller 100. The controller calculates a current load line of the circuit 20 based on the output current and the output voltage, compares the current load line with the required value, and determines whether the current load line is the required value. If the current load line is not the required value, the controller 100 changes resistance of the adjustable resistor 102, and then repeats the above steps until the load line of the circuit 20 is correct. Finally, the controller 100 sends the current load line of the circuit 20 and the resistance of the adjustable resistor 102 to the indicator 108, and then the indicator 108 indicates the resistance value to a user, and the user then removes the resistor 102 from the circuit 20 and installs a resistor of the determined value in the resistor place in the circuit 20.

In the adjusting device of the present embodiment, the controller can adjust resistance of the adjustable resistor automatically until the load line of the circuit is correctly set. Therefore, there is no need to repeatedly and manually replace resistors. Accordingly, it is convenient and efficient to use the adjusting device.

While various embodiments have been described, it is to be understood that the disclosure is not limited thereto. To the contrary, various modifications and similar arrangements (as would be apparent to those skilled in the art), are also intended to be covered. Therefore, the scope of the appended claims should be accorded the broadest interpretation so as to encompass all such modifications and similar arrangements.

What is claimed is:

1. An adjusting device for adjusting a load line of a CPU power supply circuit, the adjusting device comprising:
a controller;
a direct current (DC) electronic load device comprising a first end and a second end, the first end connected to the controller, the second end connected to the CPU power supply circuit, the controller configured for controlling the DC electronic load device to change an output current of the CPU power supply circuit;
a voltage follower comprising an input terminal and an output terminal, the input terminal connected to the circuit, the output terminal connected to the controller, the voltage follower configured for sending an output voltage of the CPU power supply circuit to the controller;
an adjustable resistor connected between the controller and the CPU power supply circuit, the adjustable resistor capable of changing a resistance of the adjustable resistor according to a signal sent by the controller, to adjust the load line of the CPU power supply circuit; and
an indicator connected to controller, the indicator configured for outputting a resistance of the adjustable resistor when the load line of the circuit satisfies a required value;
the controller being configured for calculating the load line of the circuit based on the output current and the output voltage of the circuit, determining whether the load line satisfies the required value by comparing the load line with the required value, changing a resistance of the adjustable resistor until the load line satisfies the required value, and sending a resistance of the adjustable resistor to the indicator.

2. The adjusting device of claim 1, wherein the controller is a single chip microcomputer.

3. The adjusting device of claim 2, wherein the single chip microcomputer is type PIC16F73.

4. The adjusting device of claim 1, wherein the indicator comprises a display or a speaker.

5. The adjusting device of claim 1, wherein the adjustable resistor comprises a digital potentiometer.
